(19) United States
(12) Patent Application Publication
(10) Pub. No.: US 2026/0332482 A1
(43) Pub. Date: Oct. 22, 2026

(54) NETWORK-AWARE AND ENERGY-AWARE ORCHESTRATION FOR GEOGRAPHICALLY DISTRIBUTED AI COMPUTE WORKLOADS

(71) Applicant: Aleksandr Bernhard, Biscayne Park, FL (US)

(72) Inventor: Aleksandr Bernhard, Biscayne Park, FL (US)

(73) Assignee: Solyx AI, Inc., Biscayne Park, FL (US)

(21) Appl. No.: 19/466,432

(22) Filed: Feb. 1, 2026

Related U.S. Application Data
(63) Continuation-in-part of application No. 19/438,728, filed on Jan. 2, 2026.
(60) Provisional application No. 63/750,827, filed on Jan. 29, 2025.
(60) Provisional application No. 63/755,306, filed on Feb. 7, 2025.

(51) Int. Cl. H04L 41/122; H04L 43/0852

(52) U.S. Cl. CPC H04L 41/122; H04L 43/0852

(57) ABSTRACT

A Cluster Management and Orchestration (CMO) module for network-aware and energy-aware orchestration of workloads across geographically distributed compute infrastructure. The CMO evaluates candidate execution sites based on resource availability information from an external Distributed Resource Manager (DRM), energy-related information including regional energy pricing, renewable energy availability, and demand response signals, and network performance information including wide-area network (WAN) latency from an external Software-Defined Networking (SDN) controller. The CMO determines logical placement decisions identifying preferred compute sites and coordinates resource allocation and network provisioning through the external DRM and SDN controller. The logical placement decision represents an orchestration-level determination; allocation of specific hardware resources and enforcement of constraints are performed by the DRM, and provisioning of network paths is performed by the SDN controller. This architecture enables scalable, energy-aware workload orchestration across non-co-located compute environments.

### CROSS-REFERENCE TO RELATED APPLICATIONS

This application is a continuation-in-part of U.S. non-provisional patent application Ser. No. 19/438,728 entitled “System and Method for Energy-Aware Orchestration of Distributed Artificial Intelligence Compute Using Energy Telemetry,” filed Jan. 2, 2026, which claims priority to U.S. Provisional Patent Application No. 63/750,827, filed Jan. 29, 2025.

This application further claims priority to U.S. Provisional Patent Application No. 63/755,306, entitled “Intelligent Network-Aware and Energy-Aware Orchestration for Geographically Distributed Computing Workloads,” filed Feb. 7, 2025 (the “CMO Provisional”).

The disclosures of the above-referenced applications are incorporated herein by reference in their entirety.

This application is related to the following co-pending applications: U.S. non-provisional patent application Ser. No. 19/463,891 entitled “Energy-Aware Distributed Resource Manager for Heterogeneous Hardware Accelerators” (the “DRM Application”); and U.S. Provisional Patent Application No. 63/755,097 entitled “Dynamic Path Computation and Traffic Engineering in a Virtual Full-Mesh Network for Distributed Computing with Specialized Hardware Acceleration” (the “SDN Application”). The present application, the DRM Application, and the SDN Application collectively describe components of an integrated system for energy-aware orchestration of distributed AI compute workloads.

### STATEMENT REGARDING FEDERALLY SPONSORED RESEARCH OR DEVELOPMENT

Not applicable.

### FIELD OF THE INVENTION

The present invention relates to distributed computing systems and, more particularly, to cluster management and orchestration of workloads across geographically distributed compute infrastructure. The invention is directed to logical workload placement and orchestration decisions based on network conditions, energy-related factors, and resource availability, while delegating resource allocation, enforcement, and execution to external system components.

### BRIEF DESCRIPTION OF THE DRAWINGS

FIG. 1 illustrates an example of a network-aware and energy-aware workload scheduling process.

FIG. 2 illustrates interactions between a Cluster Management and Orchestration (CMO) module, a Distributed Resource Manager (DRM), and a Software-Defined Networking (SDN) controller.

FIG. 3 illustrates an example of a distributed resource management process.

### BACKGROUND OF THE INVENTION

### Limitations Of Centralized and Site-Local Orchestration

Traditional workload orchestration systems are designed around centralized data center architectures in which compute resources are co-located within a single facility. Such systems typically assume uniform network latency and consistent energy availability and therefore focus primarily on local resource scheduling.

As artificial intelligence (AI) workloads increasingly execute across geographically distributed infrastructure, these assumptions no longer hold. Distributed compute sites may operate under significantly different network conditions, energy prices, renewable energy availability, and grid constraints.

### Lack of Integrated Network and Energy Awareness

Existing cluster management systems generally lack mechanisms to incorporate wide-area network (WAN) topology, latency variability, or regional energy conditions into workload placement decisions. In particular, conventional systems do not integrate real-time or regional energy information, such as time-of-use pricing, renewable energy availability, or demand response signals, into orchestration logic.

As a result, workloads may be placed in locations that are suboptimal with respect to cost, performance, or sustainability.

### SUMMARY OF THE INVENTION

The present invention provides a Cluster Management and Orchestration (CMO) module for network-aware and energy-aware orchestration of workloads across a geographically distributed compute network.

The CMO receives workload requests specifying execution requirements and evaluates candidate compute sites across multiple geographic locations. The evaluation is based on energy-related information, network performance characteristics, and resource availability information obtained from external systems.

Based on this evaluation, the CMO determines a logical placement decision identifying one or more preferred compute sites for execution of the workload. The placement decision represents an orchestration-level determination. The CMO does not allocate specific hardware resources or configure network paths directly.

Following the placement decision, the CMO coordinates with: an external Distributed Resource Manager (DRM) to request allocation of compute resources at the selected site(s), and an external Software-Defined Networking (SDN) controller to enable network connectivity required for workload execution.

Resource allocation, enforcement of power or quota constraints, and dynamic adjustment of hardware assignments are performed by the DRM. Network path provisioning and traffic engineering are performed by the SDN controller.

This separation of responsibilities enables scalable, energy-aware, and network-aware orchestration across non-co-located compute infrastructure.

### DETAILED DESCRIPTION OF THE INVENTION

### System Architecture

The distributed computing system comprises a plurality of compute nodes deployed across geographically distinct locations and interconnected via a wide-area network. Each compute node includes processing resources such as CPUs, memory, storage, and, in some embodiments, specialized hardware accelerators.

A Cluster Management and Orchestration (CMO) module operates as a logical orchestration layer responsible for coordinating workload placement across the distributed infrastructure. The CMO communicates with: a Distributed Resource Manager (DRM) that tracks and allocates compute resources, and a Software-Defined Networking (SDN) controller that manages network topology and connectivity.

### Cluster Management and Orchestration (CMO)

The CMO receives workload requests from users or applications. A workload request may specify compute requirements, latency constraints, energy preferences, or other execution parameters.

The CMO obtains: resource availability information from the DRM, and network topology and performance information from the SDN controller. Using this information, the CMO evaluates candidate compute sites across the distributed infrastructure and determines a logical placement decision identifying a preferred execution location.

The placement decision reflects orchestration-level considerations and does not identify specific hardware resources or network paths.

### Network-Aware and Energy-Aware Placement

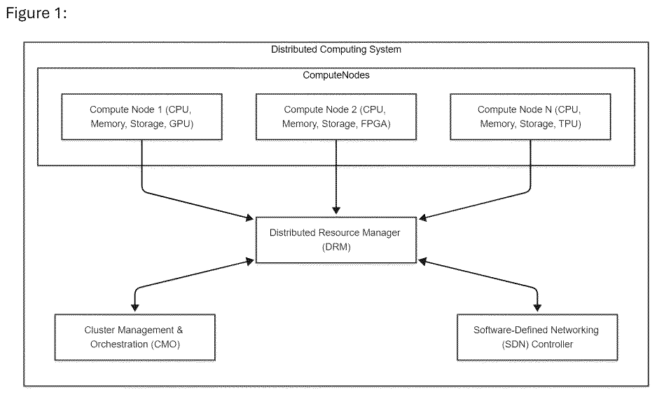

Referring to FIG. 1, the network-aware and energy-aware workload scheduling process begins with receiving a workload request. The CMO checks available resources by querying the DRM for resource availability. The CMO then queries network state from the SDN controller to obtain network topology and latency information. The CMO analyzes network and energy factors to determine a placement decision identifying a preferred compute site. Following the placement decision, resources are allocated by the DRM during workload deployment, and network paths are configured by the SDN controller during path provisioning.

In determining placement decisions, the CMO may consider one or more of: WAN latency between compute sites and data sources or end users; available bandwidth and congestion status; regional energy pricing; renewable energy availability; demand response or grid-related signals; and resource availability information provided by the DRM.

The CMO may prioritize placement at sites offering lower energy cost, higher renewable energy availability, or favorable network conditions, subject to workload execution constraints.

### Workload Classification and Type-Specific Placement

In some embodiments, the CMO classifies workloads by type and applies workload-type-specific placement policies. For latency-sensitive workloads such as real-time inference, the placement engine prioritizes compute sites with lower WAN latency to a data source or end-user location. For batch workloads without real-time latency requirements, the placement engine prioritizes compute sites with lower energy pricing or higher renewable energy availability.

### Coordination With Distributed Resource Manager

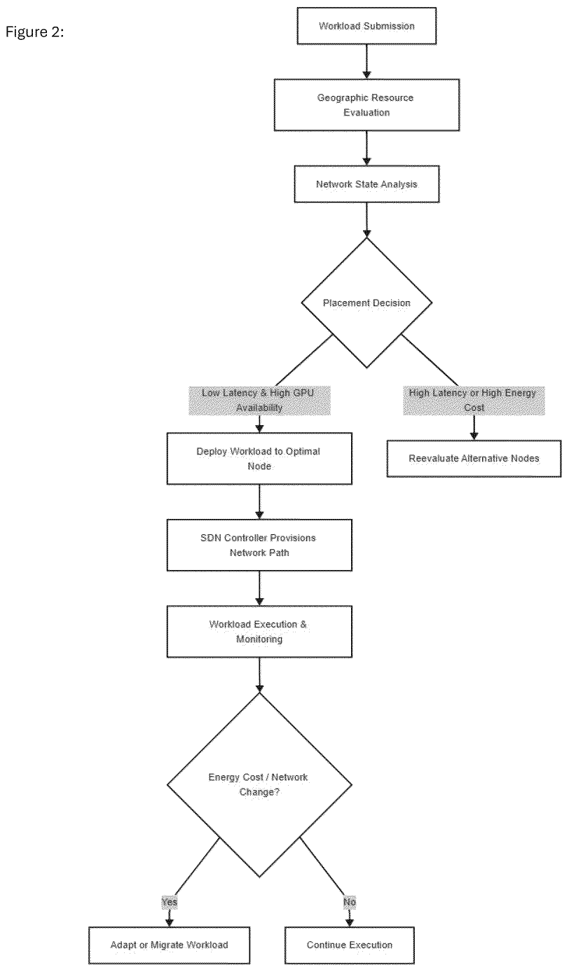

Referring to FIG. 2, the interaction between the CMO, DRM, and SDN controller proceeds as follows. The CMO receives a workload request and requests resources from the DRM. The DRM performs a resource check and returns resource availability information. The CMO fetches network state from the SDN controller, which provides topology and latency information. Based on this information, the CMO makes a placement decision. The CMO then issues an allocate resources request to the DRM, which assigns specific hardware resources. Finally, the SDN controller configures network paths to enable workload execution.

The CMO does not directly allocate or bind workloads to specific hardware resources. The DRM, as described in the related DRM Application, is responsible for resource-level allocation and enforcement.

### Coordination With Software-Defined Networking Controller

As shown in FIG. 2, the CMO coordinates with the SDN controller to enable network connectivity for deployed workloads. The SDN controller: provides network topology and performance information to the CMO, and configures network paths required for workload execution.

The CMO does not directly configure network paths but instead orchestrates network enablement through the SDN controller. The SDN controller, as described in the related SDN Application, is responsible for network path provisioning and traffic engineering.

### Distributed Resource Management

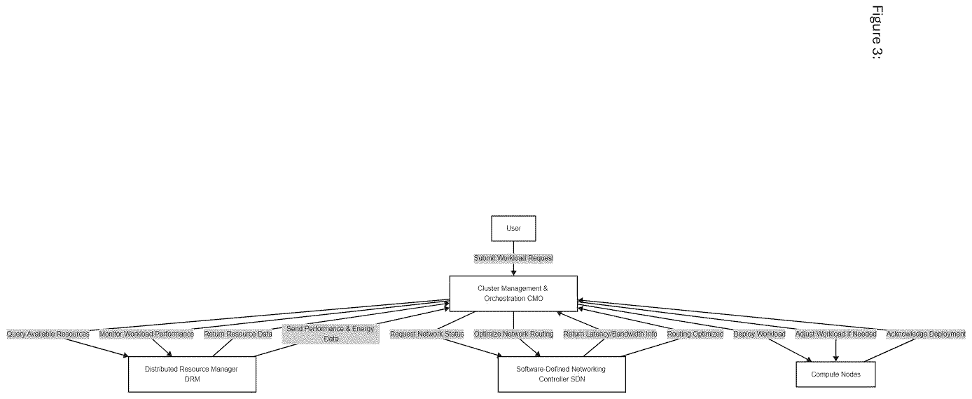

Referring to FIG. 3, the distributed resource management process performed by the DRM includes: receiving a resource request; querying available resources in a resource inventory check; evaluating allocation options to make an allocation decision; assigning optimal resources during resource assignment; and monitoring and adjusting dynamically during ongoing workload execution. This process is performed by the external DRM in response to resource allocation requests from the CMO.

### Placement Updates and Workload Migration

The CMO may monitor changes in network conditions or energy-related information. When such changes indicate that an alternative execution location may be preferable, the CMO may determine an updated logical placement decision.

The updated placement decision is communicated to the DRM and SDN controller. Execution of workload migration corresponding to the updated logical placement decision is performed by the external DRM and the external SDN controller. The CMO orchestrates migration decisions but does not execute migration mechanics directly.

### Predictive Optimization

In some embodiments, the CMO includes a predictive component configured to use historical information to inform orchestration-level placement decisions based on anticipated future energy conditions. The predictive component may schedule batch workloads for future time periods with anticipated favorable energy conditions.

### Demand Response Integration

The CMO may receive demand response signals from grid operators or energy providers. In response to demand response signals, the CMO may determine updated logical placement decisions that shift workloads away from sites subject to demand response, defer non-critical workloads, or prioritize workloads based on criticality.

### Example Use Cases

Example 1: AI Model Training. A training workload requires GPU resources across distributed sites. The CMO obtains resource availability from the DRM and network conditions from the SDN controller, evaluates candidate sites based on GPU availability, energy costs, and inter-site bandwidth, and determines a placement decision. The CMO then issues resource allocation requests to the DRM and coordinates network enablement with the SDN controller, as illustrated in FIG. 2.

Example 2: Real-Time Inference. A latency-sensitive inference workload requires low-latency responses. The CMO obtains WAN latency information from the SDN controller and determines a placement decision prioritizing sites with lowest latency to end users. Resource allocation and network provisioning are performed by the DRM and SDN controller respectively.

Example 3: Batch Processing. A non-time-sensitive batch workload is submitted. The CMO determines a placement decision prioritizing sites with high renewable energy availability, or defers the placement decision to a future time when renewable availability is expected to be higher based on predictive analysis.

Example 4: Demand Response. The CMO receives a demand response signal affecting a particular site. The CMO determines updated placement decisions for non-critical workloads at that site, coordinating with the DRM for resource reallocation and the SDN controller for network reconfiguration.

### ADVANTAGES OF THE INVENTION

Geographic Orchestration: Enables logical workload placement across non-co-located compute sites based on WAN-aware and energy-aware considerations.

Energy Awareness: Incorporates regional energy pricing, renewable availability, and demand response signals into placement decisions.

Network Awareness: Accounts for WAN latency and bandwidth variability in geographic placement decisions.

Modular Architecture: Clean separation of orchestration (CMO), resource management (DRM), and networking (SDN) functions enables scalable deployment and independent evolution of components.

Scalability: Supports distributed AI workloads without centralized data center assumptions.

What is claimed is:

1. A Cluster Management and Orchestration (CMO) module for network-aware and energy-aware orchestration of workloads across a geographically distributed compute network, comprising: a workload management component configured to receive a workload request specifying execution requirements; a resource data interface configured to obtain resource availability information for a plurality of geographically distributed compute sites from an external Distributed Resource Manager (DRM); an energy data interface configured to obtain energy-related information for the plurality of compute sites, the energy-related information including at least one of regional energy pricing, renewable energy availability, or demand response signals; a network data interface configured to obtain network topology and performance information for the plurality of compute sites from an external Software-Defined Networking (SDN) controller, the network performance information including wide-area network (WAN) latency; a placement engine configured to evaluate candidate compute sites based on the resource availability information, the energy-related information, and the network performance information, and to determine a logical placement decision identifying a preferred compute site for execution of the workload; wherein the logical placement decision represents an orchestration-level determination that does not allocate specific hardware resources or configure network paths.

2. The CMO module of claim 1, wherein the placement engine accounts for WAN latency variability between geographically distributed compute sites, distinguishing from intra-datacenter scheduling that assumes uniform low latency.

3. The CMO module of claim 1, wherein the energy-related information includes time-of-use electricity pricing that varies by geographic region, and wherein the placement engine prioritizes compute sites with lower energy pricing when determining the logical placement decision.

4. The CMO module of claim 1, wherein the energy-related information includes renewable energy availability, and wherein the placement engine prioritizes compute sites with higher renewable energy availability when determining the logical placement decision.

5. The CMO module of claim 1, wherein the workload management component classifies workloads by type, and wherein the placement engine applies workload-type-specific placement policies.

6. The CMO module of claim 5, wherein for latency-sensitive workloads, the placement engine prioritizes compute sites with lower WAN latency to a data source or end-user location.

7. The CMO module of claim 5, wherein for batch workloads without real-time latency requirements, the placement engine prioritizes compute sites with lower energy pricing or higher renewable energy availability.

8. The CMO module of claim 1, wherein following determination of the logical placement decision, the CMO module issues a resource allocation request to the external DRM, and wherein allocation of specific hardware resources and enforcement of power or quota constraints are performed by the DRM.

9. The CMO module of claim 1, wherein following determination of the logical placement decision, the CMO module coordinates with the external SDN controller to enable network connectivity, and wherein provisioning of network paths is performed by the SDN controller.

10. The CMO module of claim 1, wherein the placement engine is further configured to monitor changes in at least one of energy-related information or network performance information and to determine an updated logical placement decision when an alternative compute site becomes preferable.

11. The CMO module of claim 10, wherein execution of workload migration corresponding to the updated logical placement decision is performed by the external DRM and the external SDN controller.

12. The CMO module of claim 1, further comprising a predictive component configured to use historical information to inform orchestration-level placement decisions based on anticipated future energy conditions.

13. The CMO module of claim 12, wherein the predictive component schedules batch workloads for future time periods with anticipated favorable energy conditions.

14. The CMO module of claim 1, wherein the energy data interface is configured to receive demand response signals, and wherein the placement engine determines updated logical placement decisions in response to demand response signals.

15. A method for network-aware and energy-aware orchestration of workloads across a geographically distributed compute network, comprising: receiving, by a Cluster Management and Orchestration (CMO) module, a workload request specifying execution requirements; obtaining resource availability information for a plurality of geographically distributed compute sites from an external Distributed Resource Manager (DRM); obtaining energy-related information for the plurality of compute sites, the energy-related information including at least one of regional energy pricing, renewable energy availability, or demand response signals; obtaining network performance information for the plurality of compute sites from an external Software-Defined Networking (SDN) controller, the network performance information including wide-area network (WAN) latency; evaluating, by the CMO module, candidate compute sites based on the resource availability information, the energy-related information, and the network performance information; determining, by the CMO module, a logical placement decision identifying a preferred compute site; and coordinating, by the CMO module, with the external DRM and the external SDN controller to cause deployment of the workload in accordance with the logical placement decision.

16. The method of claim 15, wherein determining the logical placement decision comprises prioritizing compute sites with lower WAN latency for latency-sensitive workloads.

17. The method of claim 15, wherein determining the logical placement decision comprises prioritizing compute sites with lower energy pricing or higher renewable energy availability for batch workloads.

18. The method of claim 15, further comprising monitoring changes in energy-related information or network performance information and determining an updated logical placement decision when an alternative compute site becomes preferable.

19. The method of claim 18, wherein execution of workload migration corresponding to the updated logical placement decision is performed by the external DRM and the external SDN controller.

20. The method of claim 15, further comprising using historical information to inform orchestration-level placement decisions for scheduling workloads at future time periods with favorable energy conditions.
